(19) United States
(12) Patent Application Publication
(10) Pub. No.: US 2020/0012748 A1
(43) Pub. Date: Jan. 9, 2020

(54) EMULATING CLIENT BEHAVIOR IN A WIRELESS NETWORK

(71) Applicant: Cisco Technology, Inc., San Jose, CA (US)

(72) Inventors: Karthikeyan Ganesan, Campbell, CA (US); Anand Gurumurthy, San Ramon, CA (US); Vishal Satyendra Desai, San Jose, CA (US); Jerome Henry, Pittsboro, NC (US); Pooya Monajemi, Irvine, CA (US)

(21) Appl. No.: 16/026,132

(22) Filed: Jul. 3, 2018

(51) Int. Cl. G06F 17/50; H04L 29/08; H04L 12/26; H04L 12/24; G06N 99/00

(52) U.S. Cl. CPC G06F 17/5009; H04L 67/22; G06N 99/005; H04L 41/145; H04L 43/08

(57) ABSTRACT

In one embodiment, a service maintains a plurality of machine learning-based client behavioral models. Each behavioral model models wireless client behavior of a particular client type and configuration. The service selects one or more of the behavioral models to emulate the modeled one or more wireless client behaviors in a wireless network. The service controls, by using the selected one or more behavioral models, one or more emulation points in the wireless network to generate wireless client traffic in the wireless network that exhibits the modeled one or more wireless client behaviors. The service obtains performance metrics from the wireless network associated with the generated wireless client traffic.

### TECHNICAL FIELD

The present disclosure relates generally to computer networks, and, more particularly, to emulating client behavior in a wireless network.

### BACKGROUND

Wireless networks are becoming increasingly ubiquitous, with many businesses, schools, and public areas now offering wireless connectivity to authorized users and to guests. With the increasing popularity of wireless networks, the number of different types of wireless clients is also rapidly increasing. For example, personal devices now include cellular phones, tablets, wearable devices (e.g., smart watches, head-mounted displays, etc.), and the like, of various makes, models, and configurations.

From a network performance standpoint, the wide variety of different wireless client types and configurations that the network may encounter also means that the network may encounter a wide variety of different client behaviors. For example, while an Apple iPhone™ and Samsung Galaxy™ are both cellular phones, they may behave very differently on a wireless network. Even devices from the same manufacturer can exhibit different network behaviors due to differences in their firmware, software, or chipsets.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example wireless network with emulation points;

FIG. 4 illustrates an example diagram of controlling emulation points using client behavioral models; and

FIG. 5 illustrates an example simplified procedure for emulating client behavior in a wireless network.

### DESCRIPTION OF EXAMPLE EMBODIMENTS

### Overview

According to one or more embodiments of the disclosure, a service maintains a plurality of machine learning-based client behavioral models. Each behavioral model models wireless client behavior of a particular client type and configuration. The service selects one or more of the behavioral models to emulate the modeled one or more wireless client behaviors in a wireless network. The service controls, by using the selected one or more behavioral models, one or more emulation points in the wireless network to generate wireless client traffic in the wireless network that exhibits the modeled one or more wireless client behaviors. The service obtains performance metrics from the wireless network associated with the generated wireless client traffic.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

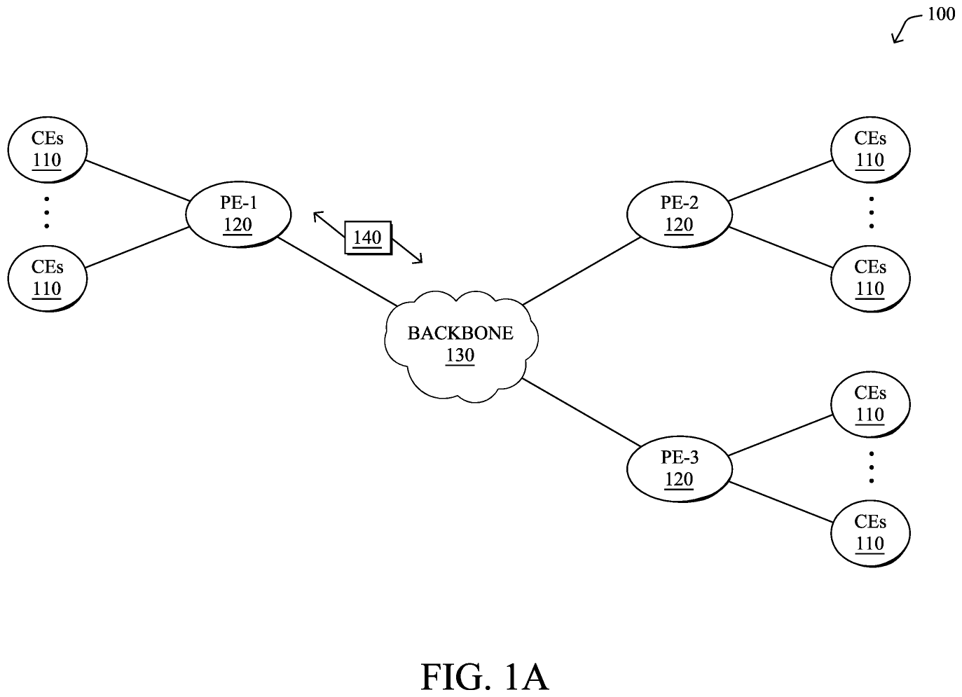

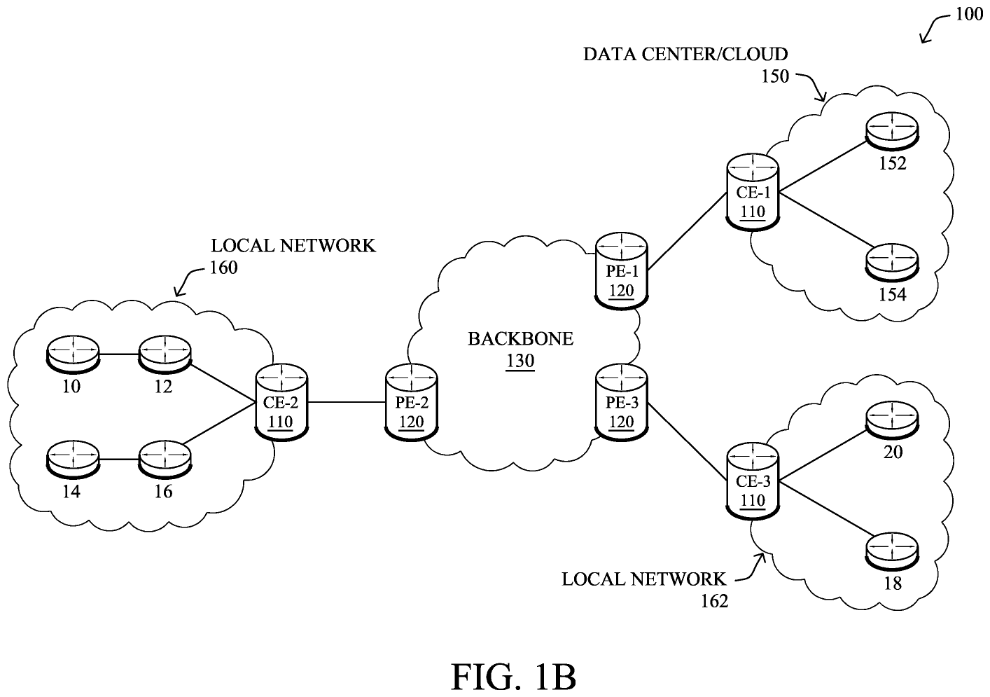

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/LTE connection). A site of type B may itself be of different types:

2a.) Site Type B1: a site connected to the network using two MPLS VPN links (e.g., from different Service Providers), with potentially a backup link (e.g., a 3G/4G/LTE connection).

2b.) Site Type B2: a site connected to the network using one MPLS VPN link and one link connected to the public Internet, with potentially a backup link (e.g., a 3G/4G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

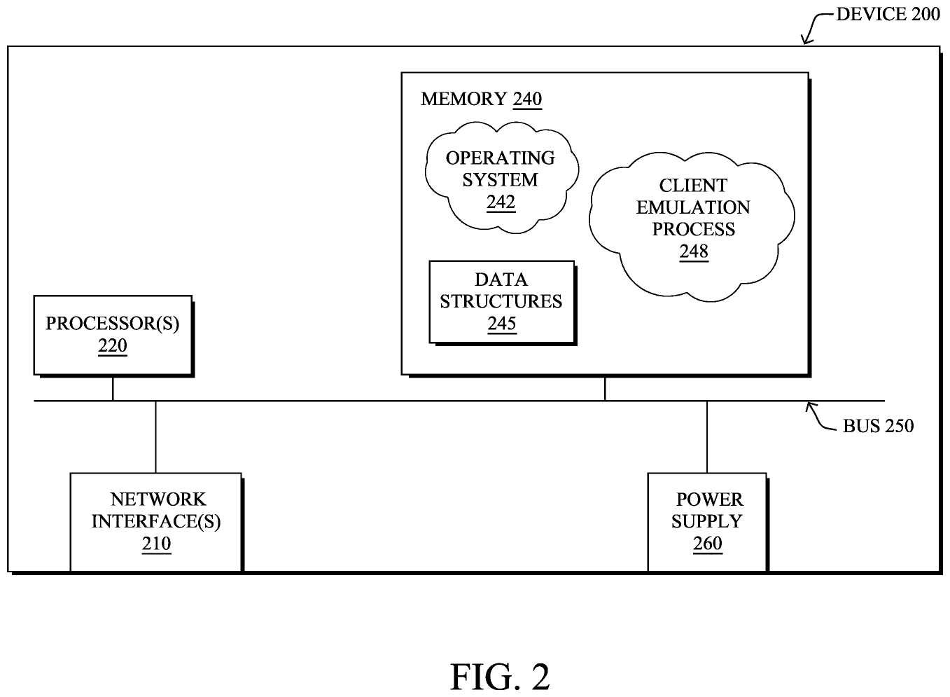

FIG. 2 is a schematic block diagram of an example computing device/node 200 that may be used with one or more embodiments described herein e.g., as any of the devices shown in FIG. 1 above or any of the devices described further below. The device may comprise one or more network interfaces 210 (e.g., wired, wireless, cellular, PLC, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network 100. The network interfaces may be configured to transmit and/or receive data using a variety of different communication protocols. Note, further, that the nodes may have two or more different types of network connections 210, e.g., wireless and wired/physical connections, and that the view herein is merely for illustration.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an illustrative client emulation process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In various embodiments, client emulation process 248 may utilize machine learning techniques, to learn and emulate client behavior in a wireless network. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

Computational entities that rely on one or more machine learning techniques to perform a task for which they have not been explicitly programmed to perform are typically referred to as learning machines. In particular, learning machines are capable of adjusting their behavior to their environment. For example, a learning machine may dynamically make future predictions based on current or prior network measurements, may make control decisions based on the effects of prior control commands, etc.

For purposes client emulation in a wireless network, a learning machine may construct a model of the observed behavior of a given client or type of client. Such a model can then be used in the wireless network to emulate the presence of the client or type of client in the wireless network for purposes of testing and diagnostics. Example machine learning techniques that may be used to construct such a model may include, but are not limited to, nearest neighbor (NN) techniques (e.g., k-NN models, replicator NN models, etc.), statistical techniques (e.g., Bayesian networks, etc.), clustering techniques (e.g., k-means, etc.), neural networks (e.g., reservoir networks, artificial neural networks, etc.), support vector machines (SVMs), or the like.

One class of machine learning techniques that is of particular use in the context of client emulation is clustering. Generally speaking, clustering is a family of techniques that seek to group data according to some typically predefined notion of similarity. For instance, clustering is a very popular technique used in recommender systems for grouping objects that are similar in terms of people's taste (e.g., because you watched X, you may be interested in Y, etc.). Typical clustering algorithms are k-means, density based spatial clustering of applications with noise (DBSCAN) and mean-shift, where a distance to a cluster is computed with the hope of reflecting a degree of similarity (e.g., using a Euclidian distance and a cluster based local outlier factor that takes into account the cluster density). More specifically, in some embodiments, behavioral data for clients of the same type can be clustered and used to train a behavioral model for that type of client.

Replicator techniques may also be used for purposes of anomaly detection. Such techniques generally attempt to replicate an input in an unsupervised manner by projecting the data into a smaller space (e.g., compressing the space, thus performing some dimensionality reduction) and then reconstructing the original input, with the objective of keeping the “normal” pattern in the low dimensional space. Example techniques that fall into this category include principal component analysis (PCA) (e.g., for linear models), multi-layer perceptron (MLP) ANNs (e.g., for non-linear models), and replicating reservoir networks (e.g., for non-linear models, typically for time series).

According to various embodiments, client emulation process 248 may also use graph-based models for purposes of modeling and emulating client behavior. Generally speaking, a graph-based model attempts to represent the relationships between different entities as a graph of nodes interconnected by edges. For example, ego-centric graphs have been used to represent the relationship between a particular social networking profile and the other profiles connected to it (e.g., the connected “friends” of a user, etc.). The patterns of these connections can then be used for purposes of emulating client behavior.

As noted above, the types and configurations of wireless devices that a wireless network may encounter are ever increasing. From a network performance standpoint, this makes configuring the network progressively more difficult, as it is challenging to determine how the network will perform under different conditions.

One approach to assessing the response of a wireless network under different conditions is to test the network by replaying captured network traffic and measuring how the wireless network performs. While this approach does allow for some degree of network testing, such an approach also does not typically reflect current application patterns, nor account for changing client and network behaviors due to real and changing radio frequency (RF) conditions (e.g. elastic codecs in high density, etc.). Other approaches, such as load-testing using generic traffic flows, similarly fail to replicate actual network conditions.

Emulating Client Behavior in a Wireless Network

The techniques herein allow for the emulation of certain parameters and behaviors of real clients in a wireless network by various emulation points distributed throughout the network. In some aspects, machine learning can be leveraged to create behavioral profiles (with parameters) for each client type and configuration (e.g., firmware/software version, hardware, etc.). Such information can be obtained based on vendor supplied data, one time lab analysis/sniffing, and/or by learning the behavioral profiles in a live network over time, and stored in a database to create the behavioral profiles. In further aspects, the techniques herein introduce a time slicing methodology that allows for the capture of client behavioral information in a holistic yet light manner. Using the behavioral models, combinations of learned parameters can be provided to the emulation points in the wireless network to emulate traffic from one or more emulated clients, resulting in a more realistic RF environment simulation for purposes of analyzing and testing the performance of the infrastructure and/or real clients attached to the network.

Specifically, according to one or more embodiments of the disclosure as described in detail below, a service maintains a plurality of machine learning-based client behavioral models. Each behavioral model models wireless client behavior of a particular client type and configuration. The service selects one or more of the behavioral models to emulate the modeled one or more wireless client behaviors in a wireless network. The service controls, by using the selected one or more behavioral models, one or more emulation points in the wireless network to generate wireless client traffic in the wireless network that exhibits the modeled one or more wireless client behaviors. The service obtains performance metrics from the wireless network associated with the generated wireless client traffic.

Illustratively, the techniques described herein may be performed by hardware, software, and/or firmware, such as in accordance with the client emulation process 248, which may include computer executable instructions executed by the processor 220 (or independent processor of interfaces 210) to perform functions relating to the techniques described herein.

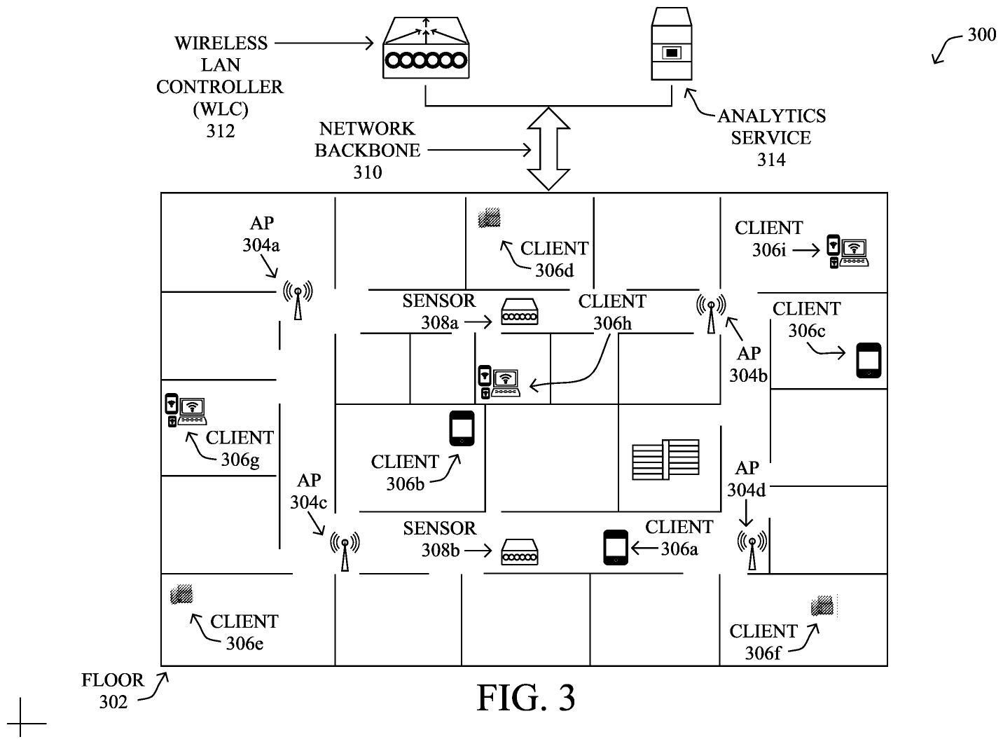

Operationally, FIG. 3 illustrates an example wireless network 300, according to various embodiments. Wireless network 300 may be deployed to a physical location, such as floor 302 shown, and may include various infrastructure devices. These infrastructure devices may include, for example, one or more access points (APs) 304 that provide wireless connectivity to the various wireless clients 306 distributed throughout the location. For illustrative purposes, APs 304a-304d and clients 306a-306i are depicted in FIG. 3. However, as would be appreciated, a wireless network deployment may include any number of APs and clients.

A network backbone 310 may interconnect APs 304 and provide a connection between APs 304 and any number of supervisory devices or services that provide control over APs 304. For example, as shown, a wireless LAN controller (WLC) 312 may control some or all of APs 304a-404d, by setting their control parameters (e.g., max number of attached clients, channels used, wireless modes, etc.). Another supervisory service that oversees wireless network 300 may be an analytics service 314 that measures and monitors the performance of wireless network 300 and, if so configured, may also adjust the operation of wireless network 300 based on the monitored performance (e.g., via WLC 312, etc.).

Network backbone 310 may further provide connectivity between the infrastructure of the local network and a larger network, such as the Internet, a Multiprotocol Label Switching (MPLS) network, or the like. Accordingly, WLC 312 and/or analytics service 314 may be located on the same local network as APs 304 or, alternatively, may be located remotely, such as in a remote datacenter, in the cloud, etc. To provide such connectivity, network backbone 310 may include any number of wired connections (e.g., Ethernet, optical, etc.) and/or wireless connections (e.g., cellular, etc.), as well as any number of networking devices (e.g., routers, switches, etc.).

In some embodiments, wireless network 300 may also include any number of wireless network sensors 308, such as sensors 308a-308b shown. In general, “wireless network sensors” are specialized devices that are able to act as wireless clients and perform testing on wireless network 300 and are not to be confused with other forms of sensors that may be distributed throughout a wireless network, such as motion sensors, temperature sensors, etc. In some cases, an AP 304 can also act as a wireless network sensor, by emulating a client in the network for purposes of testing communications with other APs. Thus, emulation points in network 300 may include dedicated wireless network sensors 308 and/or APs 304, if so configured.

During operation, the purpose of an emulation point in network 300 is to act as a wireless client and perform tests that include connectivity, performance, and/or negative scenarios, and report back on the network behavior to analytics service 314. In turn, analytics service 314 may perform analytics on the obtained performance metrics, to identify potential network issues before they are reported by actual clients. If such an issue is identified, analytics service 314 can then take corrective measures, such as changing the operation of network 300 and/or reporting the potential issue to a network administrator or technician.

As noted above, the types and configurations of clients 304 in network 300 can vary greatly. For example, clients 306a-306c may be mobile phones, clients 306d-306f may be office phones, and clients 306g-306i may be computers, all of which may be of different makes, models, and/or configurations (e.g., firmware or software versions, chipsets, etc.). Consequently, each of clients 306a-306i may behave very differently in wireless network 300 from both RF and traffic perspectives.

According to various embodiments, the techniques herein allow an emulation point (e.g., AP 304 and/or sensor 308) to emulate any specific device that is in the field, based on changes to the driver and supplicant parameters like Enhanced Distributed Channel Access (EDCA) Wi-Fi Multimedia (WMM), security mode, changes to the 802.11 management packets and/or timing, support for various 802.11 extensions, roaming threshold, etc. This includes defining the parameters/timing/flow/support that changes from one client to another. For example, the techniques herein can be used to have wireless network sensor 308a emulate an iPhone 5s running iOS version 10.1 and participating in a video conference, while wireless network sensor 308b emulates a Samsung Galaxy s9 running Android OS version 8.1 and visiting various websites. By pushing synthetic test parameters to the client(s) emulated by the emulation points, analytics service 314 is able to identify real-world, device-specific issues in network 300, in addition to generic client issues that may arise. In addition, the emulated client behaviors can be expanded into creating scale scenarios (e.g., use wireless network sensor 308a to emulate twenty iPhones that are sending data for use as background traffic and use wireless network sensor 308b to test the network under these conditions).

At the core of the techniques herein is the construction of client behavioral models using machine learning that are able to emulate the wireless behaviors of the various types of clients that the network may encounter. Such behavioral models may be trained using any or all of the following data sources:
Lab Study—each client can be tested in a lab environment with parameters derived from sniffing and by capturing data from the client interface and/or debug logs.
Machine Learning in Actual Deployments—machine learning can also be used in actual wireless network deployments to capture and model the behaviors of the various wireless clients in the network.
Vendor-Provided Behavioral Data—in some cases, wireless client vendors could supply the behavioral training data for a behavioral model or, alternatively, supply a pre-trained behavioral model itself.
User Configuration—expert users also may serve as a potential source of information regarding the behaviors of the different wireless client devices.

In some embodiments, the client behavioral models may be trained using a time slice-based database of observed client behaviors. Such a dynamic learning approach may leverage any or all of the following:
1) Observed time slices. As would be appreciated, client devices do not perform the same tasks or exhibit the same 802.11 behaviors at all times. By discretizing the observed behaviors into different time slices, a more accurate model can be trained. For example, the following behaviors can be segregated using time slicing:
   a. Initial connection to the network will display a typical choreography sequence (e.g., 802.11 phases followed by registration to one or more push services, update/pull related to app data or updates, followed by a ‘quiet down’ phase). The pattern of this sequence may be observed and learned as part of the behavioral model. Note that the actual content of the exchange is irrelevant to the training, just the observed management/data/control frame sequence and mix, as well as frame size.
   b. Inactivity periods also follow a standard sequence. For example, behavioral data can be captured for these periods regarding information such as the inclusion of a de-authentication or not, keepalives at intervals with the Power Management bit set to 0/1, directed or best probes at interval, wake up at intervals for pull/updates, and the like.
   c. Each Layer 7 application also displays a typical choreography that can be observed and learned by the model. For example, VoFI registration, keep alives, call initiation patterns, etc., can be learned and mapped to a time slice behavior.
2) Information about the communicating application(s) of the client can also be learned and modeled. For example, Application Visibility and Control (AVC) by Cisco Systems, Inc. is able to identify the particular application associated with a traffic flow. In some cases, this application information can be coupled with the device profiling information from above, to provide even more granularity to the client behavioral model. Notably, section 1.c above provides UP identification, AVC or a similar application identification system adds more granularity in application identification. For example, adding in application information allows for distinctions such as “this is a Lync call setup pattern,” “this is a Spark call setup pattern,” “this is a voice setup pattern,” etc. Doing so allows the behavioral model to also learn the associated application-specific behavior. Note that the content of the traffic exchange itself (e.g., the audio payload in an encrypted voice call, the video contents, etc.) is irrelevant for purposes of model training, as long as the system learns the correct pattern needed to reproduce this traffic type (e.g., 180 bytes frames at 20 ms intervals, etc.).
3) RF conditions coupling can also be modeled. As would be appreciated, wireless client behavior typically changes with RF conditions. The changes go beyond simply the data rate and associated payload airtime consumption, although these elements are also computed, and may include thresholds at which specific frames appear or stop. For example, the following RF-dependent behaviors can also be modeled: x retry bits followed by probe requests, received signal strength indicator (RSSI) thresholds beyond which control or management frames appear or stop, or beyond which app behavior change (e.g., switch to LTE, codec change, etc.), and the like.

To perform the behavior modeling, elastic time slices can be used that characterize individual device behavior for individual sections of events described above. In some embodiments, for each time slice, the mix of management/control frame types and durations, data frames and durations and time slice duration may be graphed in an n-dimensional space, and alike or similar devices and/or applications are grouped using a clustering technique. This approach allows for very granular observation of the different moments of a device existence in the cell, and allows for easy characterization of changes (e.g., a voice application update that will change the initial link setup pattern, but will not change the codec flow or the termination sequence, etc.). Applied this way, this method allows an analytics service to record moment-behavior slices associated with device types, RF conditions, and applications.

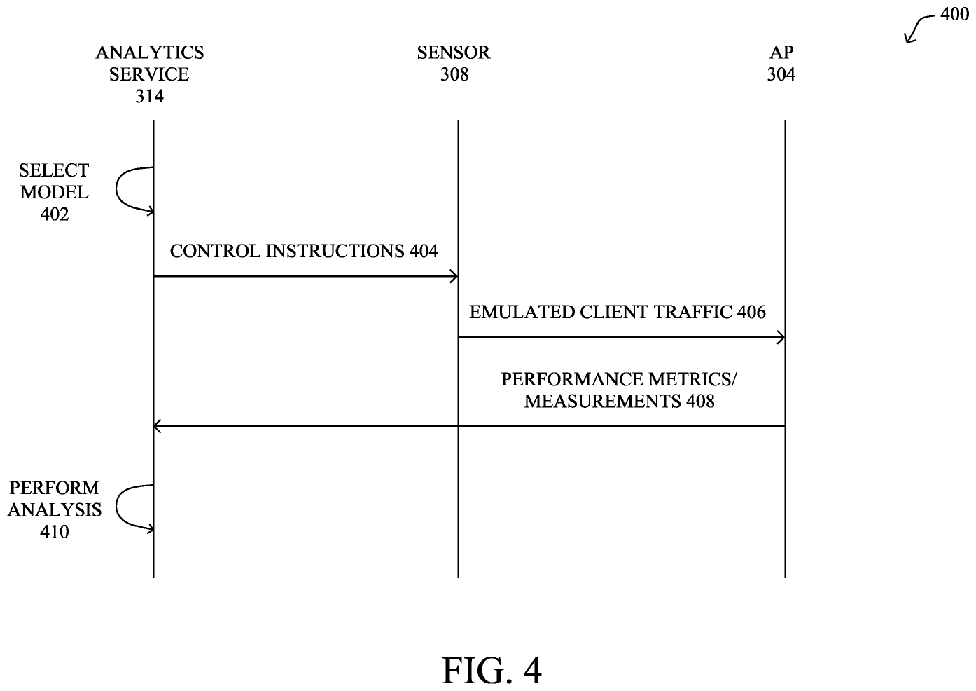

FIG. 4 illustrates an example diagram 400 of controlling emulation points using client behavioral models, in various embodiments. Continuing the example of FIG. 3, assume that analytics service 314 maintains a plurality of client behavioral models, with each behavioral model modeling the wireless client behavior of a particular client type and configuration. In various embodiments, any or all of the following parameters may be included in the behavioral model/profile for a given client type and configuration:
Number of antennas/spatial streams—the number of active RF chains on the device, as well as number of spatial streams used in transmissions. Note that 11ax devices may also dynamically change their operating mode (ROMI/TOMI)
Transmit power—transmitted power of the client can be modeled in conjunction with its path loss to the AP by varying the transmission power of the emulation point (e.g., using constructive or destructive interference, etc.).
Support for various transmission modes—e.g., uplink multi-user (UL-MU)/UL MU/Orthogonal Frequency-Division Multiple Access (OFDMA) in 802.11ax
Participation mechanism in triggered UL-MU vs. single user (SU) contention in 802.11ax.
Timing accuracy—various timing aspects can be modeled, including CFO and triggered UL-MU response timing.
Feature Support—for example, support for DTPC, 802.11v, 802.11k, etc. Specifically, a client's response to BSS transition management frames may be of interest and modeled.
Probing behavior—e.g., the thresholds and intervals at which the client will start to send probe requests on other channels.
Power-save modes—e.g., whether and when the client may use various power saving mechanisms such as TWT, or wake-up radio.
Association behavior
Authentication behavior
Roaming behavior—e.g., stickiness, scanning thresholds, pattern, roaming choreography, including power management bits and exchanges with neighboring APs)
Upper Layer behaviors—this can include mandatory services such as DHCP or DNS behavior
Quality of Service (QoS) behaviors—e.g., UP markings, WMM timers and support, etc.
Post-connectivity behaviors that are client specific—for example, an iPhone may contact Apple.com, get push notification registration, contact a 3gpp.org server to set VoFi, etc.

As shown, analytics service 314 may select any number of behavioral models (step 402), to test the wireless network by emulating one or more clients in the network. Various possibilities exist with respect to this testing. For example, analytics service 314 may select the behavioral model(s) for any or all of the following:
Real device stress test/database augmentation—in this mode, a real device is progressively exposed to competing traffic matching various recorded types (e.g., competing voice call(s), one or many parallel sensor-simulated devices probing, etc.). In some embodiments, this phase can also be used for purposes of reinforcement learning, to augment the behavioral database of the analytics service with learned modified behavior, such as in congestion conditions. Note that during implementation, mild competition can be introduced for real devices exchanging traffic on low UPs, while heavy competition should be reserved for calibration phases.
Event simulations—in this mode, one or more emulation points can be programmed to exhibit the conditions of specific events. For example, assume that the wireless network serves a large public venue, such as a train station. In such a case, one event may entail emulating 200 clients attempting to join the network at the same time. In such a case, the emulation may entail emulating the first twenty seconds of traffic after association takes place (e.g., emulating a dense VoIP scenario by increasing the number of simulated calls through one or more APs). The combinations of possible behaviors for an even simulation are as wide as the number of permutations in the database.

In both scenarios above, PHY parameters can also be modeled and reproduced. For example, emulation point gain can be manipulated by leveraging constructive or destructive interference and/or by adjusting the transmit power. Doing so may introduce noise to manipulate the observed RSSI or signal to interference plus noise ratio (SINR) by the receiving AP. In further embodiments, some emulation points can also be used to create random signals and increase the noise floor artificially for other participating endpoints.

Using the selected behavioral model(s), analytics service 314 may send control instructions 404 to a wireless network sensor 308 or other emulation point in the network (e.g., an AP), either directly or via a WLC that provides supervisory control over the emulation point. Such instructions may identify any or all of the behavioral parameters modeled by the model/profile for the client that is to be emulated. For example, control instructions 404 may specify the transmit power, power saving behavior, probing behavior, and the like, of the client to be emulated.

After receiving control instructions 404, wireless network sensor 308 may begin generating emulated network traffic 406 that emulates the presence of the modeled client in the wireless network. Notably, traffic 406 may exhibit the modeled client behavior(s) of the corresponding behavioral model of the client. In turn, AP 304 may receive the generated traffic 406 and record any number of network performance metrics/measurements. In other words, AP 304 may capture data indicative of how the wireless network responds to the presence of the emulated client in the network. AP 304 may then provide the captured metrics/measurements 408 to analytics service 314, which uses this information to perform analysis on the wireless network (step 410). Such analysis may be used for purposes of effecting changes to the network, either automatically or manually, reporting, or the like.

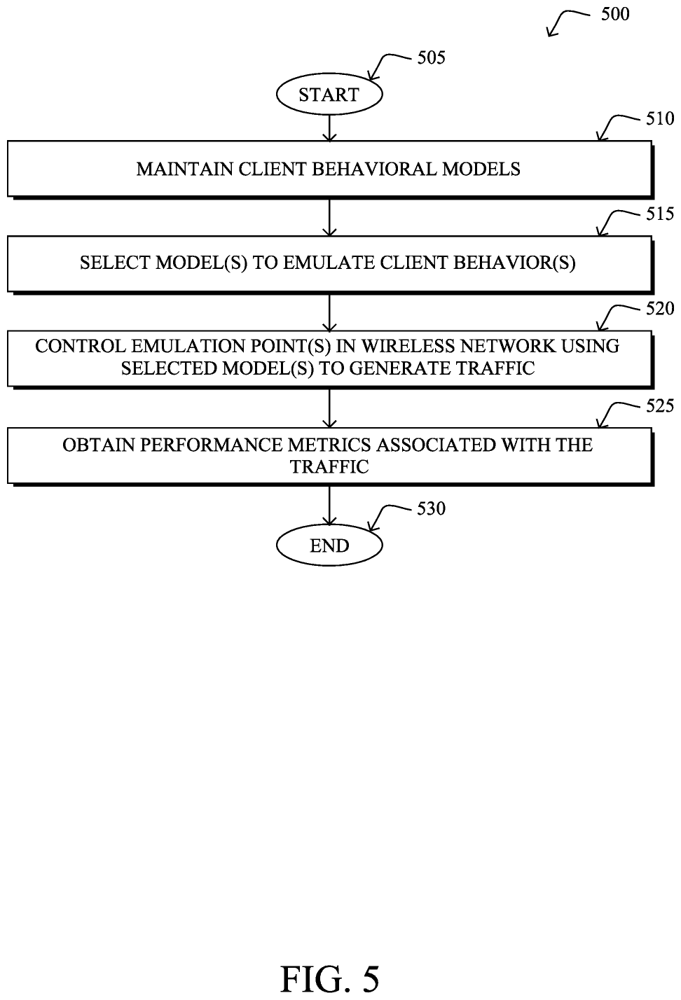

FIG. 5 illustrates an example simplified procedure for emulating client behavior in a wireless network, in accordance with one or more embodiments described herein. For example, a non-generic, specifically configured device (e.g., device 200) may perform procedure 500 by executing stored instructions (e.g., process 248), to provide an analytics service. The procedure 500 may start at step 505, and continues to step 510, where, as described in greater detail above, the service may maintain a plurality of machine learning-based client behavioral models. In various embodiments, each behavioral model models wireless client behavior of a particular client type and configuration. For example, one model may model the wireless behavior of an iPhone 8 running a particular OS, while another model may model the wireless behavior of a particular IoT device running a particular firmware version. Such modeled behavior may model any of the parameters described previously including, but not limited to, 802.11ax transmission mode usage behavior, client roaming behavior, wireless probing behavior, transmit power level, number of radio chains used, power saving behavior, network association behavior, or network authentication behavior of the client.

At step 515, as detailed above, the service may select one or more of the behavioral models to emulate the modeled one or more wireless client behaviors in a wireless network. For example, the service may opt to run a stress test or event simulation in which any number of emulated clients generates traffic in the wireless network.

At step 520, the service may control, using the selected one or more behavioral models, one or more emulation points in the wireless network to generate wireless client traffic in the wireless network that exhibits the modeled one or more wireless client behaviors. For example, the service may instruct a wireless network sensor or an AP in client mode to generate network traffic that exhibits the modeled wireless behavior of the emulated client(s).

At step 525, as detailed above, the service may obtain performance metrics from the wireless network associated with the generated wireless client traffic. In particular, the service may receive measurements from the wireless network indicative of how the network responds in the presence of the emulated client(s). For example, the AP(s) in the network that receive the generated network traffic that In turn, the service may use the performance metrics for purposes of reporting, changing the operation of the network (e.g., by reconfiguring an AP, etc.), or the like. Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for the emulation of client devices in a wireless network that reflect actual, learned wireless behaviors of the emulated clients. As would be appreciated, this provides a considerable advantage over “recorded” methods (e.g., where a Skype call is captured and recorded, then replayed). Notably, testing methods that rely on recordings only reproduce the conditions of the recording, thus ignoring app/OS version changes, impact of RF conditions on application behavior, impact of competing traffic on app behavior, such as codec compression or elasticity, etc. By contrast, the techniques introduced herein are able to account for these changes. In addition, the time slicing approach introduced herein also limits the storage required to characterize the wireless behaviors of a client and, in some embodiments, allows for similar time slices to be clustered for different applications, further reducing the storage requirements.

While there have been shown and described illustrative embodiments that provide for emulating client behavior in a wireless network, it is to be understood that various other adaptations and modifications may be made within the spirit and scope of the embodiments herein. For example, while certain embodiments are described herein with respect to using certain models for purposes of modeling client behaviors, the models are not limited as such and may be used for other functions, in other embodiments. In addition, while certain protocols are shown, such as Wi-Fi, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
maintaining, by a service, a plurality of machine learning-based client behavioral models, wherein each behavioral model models wireless client behavior of a particular client type and configuration;
selecting, by the service, one or more of the behavioral models to emulate the modeled one or more wireless client behaviors in a wireless network;
controlling, by the service and using the selected one or more behavioral models, one or more emulation points in the wireless network to generate wireless client traffic in the wireless network that exhibits the modeled one or more wireless client behaviors; and
obtaining, by the service, performance metrics from the wireless network associated with the generated wireless client traffic.

2. The method as in claim 1, wherein the modeled wireless network behavior comprises one or more of: 802.11ax transmission mode usage behavior, client roaming behavior, or wireless probing behavior.

3. The method as in claim 1, wherein the one or more emulation points comprise at least one of: a wireless network sensor or a wireless access point.

4. The method as in claim 1, wherein controlling the one or more emulation points comprises:
instructing the one or more emulation points to use constructive or destructive interference to generate the wireless client traffic with a particular received signal strength indicator (RSSI) or signal to interference plus noise ratio (SINR).

5. The method as in claim 1, further comprising:
training, by the service, one of the machine learning-based client behavioral models using reinforcement learning in part by progressively exposing a wireless device in the wireless network to competing traffic.

6. The method as in claim 1, further comprising:
training, by the service, one of the machine learning-based client behavioral models in part by forming a multi-dimensional space of time slices, each time slice being associated with control or data frames observed for a client during the time slice.

7. The method as in claim 1, wherein the modeled wireless network behavior comprises one or more of: a transmit power level, a number of radio chains used, power saving behavior, network association behavior, or network authentication behavior.

8. The method as in claim 1, wherein controlling the one or more emulation points in the wireless network comprises:
controlling the one or more emulation points to create random signals, to artificially increase a nose floor.

9. The method as in claim 1, wherein selecting the one or more of the behavioral models to emulate the modeled one or more wireless client behaviors in a wireless network comprises:
selecting the one or more behavioral models to simulate an event involving a plurality of wireless clients in the wireless network.

10. The method as in claim 1, wherein controlling the one or more emulation points in the wireless network comprises:
sending an instruction to a wireless local area network controller that controls the one or more emulation points.

11. An apparatus comprising:
one or more network interfaces to communicate with a wireless network;
a processor coupled to the network interfaces and configured to execute one or more processes; and
a memory configured to store a process executable by the processor, the process when executed configured to:
maintain a plurality of machine learning-based client behavioral models, wherein each behavioral model models wireless client behavior of a particular client type and configuration;
select one or more of the behavioral models to emulate the modeled one or more wireless client behaviors in a wireless network;
control, by using the selected one or more behavioral models, one or more emulation points in the wireless network to generate wireless client traffic in the wireless network that exhibits the modeled one or more wireless client behaviors; and
obtain performance metrics from the wireless network associated with the generated wireless client traffic.

12. The apparatus as in claim 11, wherein the modeled wireless network behavior comprises one or more of: 802.11ax transmission mode usage behavior, client roaming behavior, or wireless probing behavior.

13. The apparatus as in claim 11, wherein the one or more emulation points comprise at least one of: a wireless network sensor or a wireless access point.

14. The apparatus as in claim 11, wherein the apparatus controls the one or more emulation points by:
instructing the one or more emulation points to use constructive or destructive interference to generate the wireless client traffic with a particular received signal strength indicator (RSSI) or signal to interference plus noise ratio (SINR).

15. The apparatus as in claim 11, wherein the process when executed is further configured to:
train one of the machine learning-based client behavioral models using reinforcement learning in part by progressively exposing a wireless device in the wireless network to competing traffic.

16. The apparatus as in claim 11, wherein the process when executed is further configured to:
train one of the machine learning-based client behavioral models in part by forming a multi-dimensional space of time slices, each time slice being associated with control or data frames observed for a client during the time slice.

17. The apparatus as in claim 11, wherein the modeled wireless network behavior comprises one or more of: a transmit power level, a number of radio chains used, power saving behavior, network association behavior, or network authentication behavior.

18. The apparatus as in claim 11, wherein the apparatus controls the one or more emulation points in the wireless network by:
controlling the one or more emulation points to create random signals, to artificially increase a nose floor.

19. The apparatus as in claim 11, wherein the apparatus selects the one or more of the behavioral models to emulate the modeled one or more wireless client behaviors in a wireless network by:
selecting the one or more behavioral models to simulate an event involving a plurality of wireless clients in the wireless network.

20. A tangible, non-transitory, computer-readable medium storing program instructions that cause a service to execute a process comprising:
maintaining, by the service, a plurality of machine learning-based client behavioral models, wherein each behavioral model models wireless client behavior of a particular client type and configuration;
selecting, by the service, one or more of the behavioral models to emulate the modeled one or more wireless client behaviors in a wireless network;
controlling, by the service and using the selected one or more behavioral models, one or more emulation points in the wireless network to generate wireless client traffic in the wireless network that exhibits the modeled one or more wireless client behaviors; and
obtaining, by the service, performance metrics from the wireless network associated with the generated wireless client traffic
